(19) United States
(12) Patent Application Publication
(10) Pub. No.: US 2009/0101486 A1
(43) Pub. Date: Apr. 23, 2009

(54) TRIGGERING STRUCTURE

(76) Inventor: Ming Tay HSU, Taoyuan Hsien (TW)

Correspondence Address: HDLS Patent & Trademark Services, P.O. BOX 220746, CHANTILLY, VA, 20153-0746, US

(21) Appl. No.: 12/252,416

(22) Filed: Oct. 16, 2008

(30) Foreign Application Priority Data
Oct. 23, 2007 (TW) 096217706

(51) Int. Cl. H01H 5/00

(52) U.S. Cl. 200/468

(57) ABSTRACT

A triggering structure provided in a housing includes a circuit body, a pillar, an elastic part, a light-emitting part, and a power supply unit. Part of the pillar in the housing is exposed. When being pushed with an external force to draw back to the inside of housing, the pillar may make the contact points disconnecting from each other in the circuit body, thereby the light-emitting part being made to light; contrarily, when the pillar normally extends out of the housing, the circuit where the disconnected contact points is not turned ON by the pillar is open, and thus the light-emitting part does not work. Depending on a service state, the triggering structure may automatically enable and disable a sound-light part and may be applied to various products.

### BACKGROUND OF THE INVENTION

1. Field of the Invention

This invention relates to a triggering structure and particularly to an automatic switch structure that is in the form of a pillar contracting or extending to make the inner structure link to turn ON a point of contact, thereby a sound-light component to be controlled being automatically open or close.

2. Description of the Related Art

If functioning to give out light or sound, a set of conventional stationery, a toy, or a random product is probably provided with a manual switch that is manually operated to enable or disable a sound-light component. However, along with a progressive technology, various automatic switches are widely applied to products; for example, a light-sensitive resistor goes with the intensity of light to form an automatic sensor switch, or goes with infrared to form the switch. The switches are generally named an electronic automatic sensor switch and are not applicable in some cases. In this invention, a linkage switch structure is provided and implemented in predetermined cases that make up for what other types of electronic switches have lost.

Consequently, because of the technical defects of described above, the applicant keeps on carving unflaggingly through wholehearted experience and research to develop the present invention, which can effectively improve the defects described above.

### SUMMARY OF THE INVENTION

An automatically sensitive triggering switch is provided as a triggering structure according to this invention that uses a pillar as a base of triggering and electric conduction. When the pillar is touched with an external force, inner contact points that are separate and disconnect may be turned ON to enable or disable a light-sound component for automatic control.

In order to achieve the objective mentioned above, the structure according to this invention comprises a circuit, a pillar, an elastic part, a light-emitting part, and a power supply unit. In the housing, part of the pillar is exposed, and when being touched with an external force to draw back to the inside of housing, the pillar may make the contact points disconnecting from each other in the PCB, thereby the light-emitting part being made to light. Alternatively, when the pillar normally extends out of the housing, the circuit where the disconnected contact points is not turned ON by the pillar is open, and thus the light-emitting part does not work.

### BRIEF DESCRIPTION OF THE DRAWINGS

FIG. 1 is an exploded view of this invention;

FIG. 2 is a partial assembly view of this invention;

FIG. 3 is a partially exploded 3D view of this invention;

FIG. 4 is a sectional view of this invention;

FIG. 5 is another sectional view of this invention;

FIG. 6 is a view of a service state of this invention;

FIG. 7 is a view of another service state of this invention;

FIG. 8 is a next sectional view of this invention; and

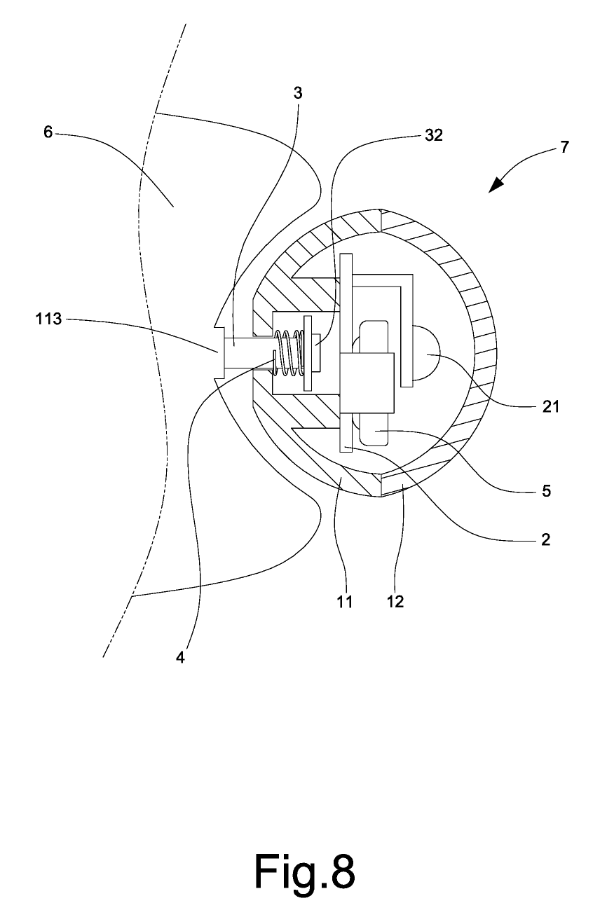

FIG. 9 is an even next sectional view of this invention.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

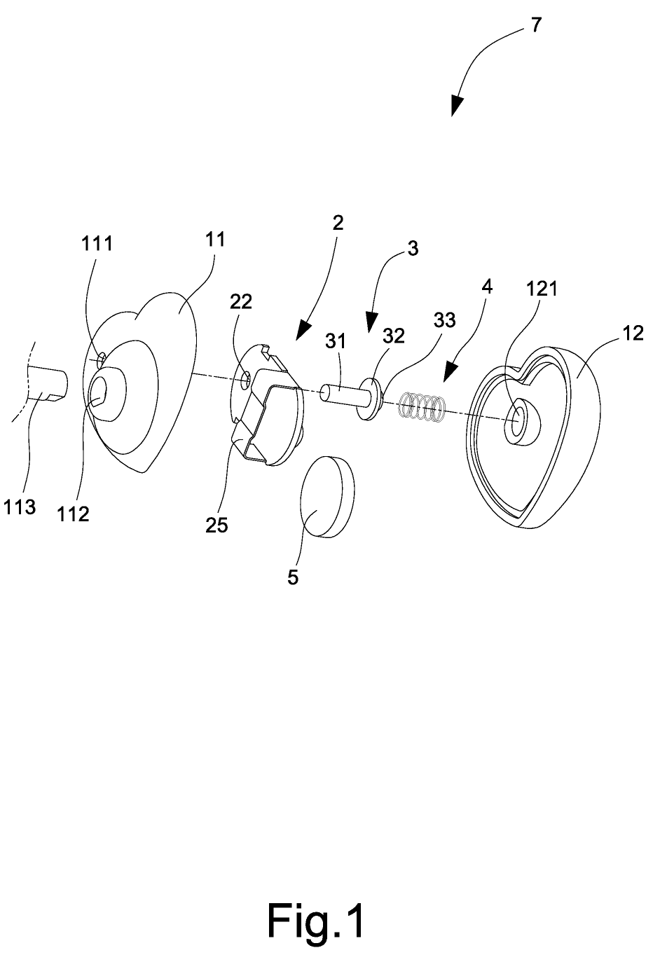

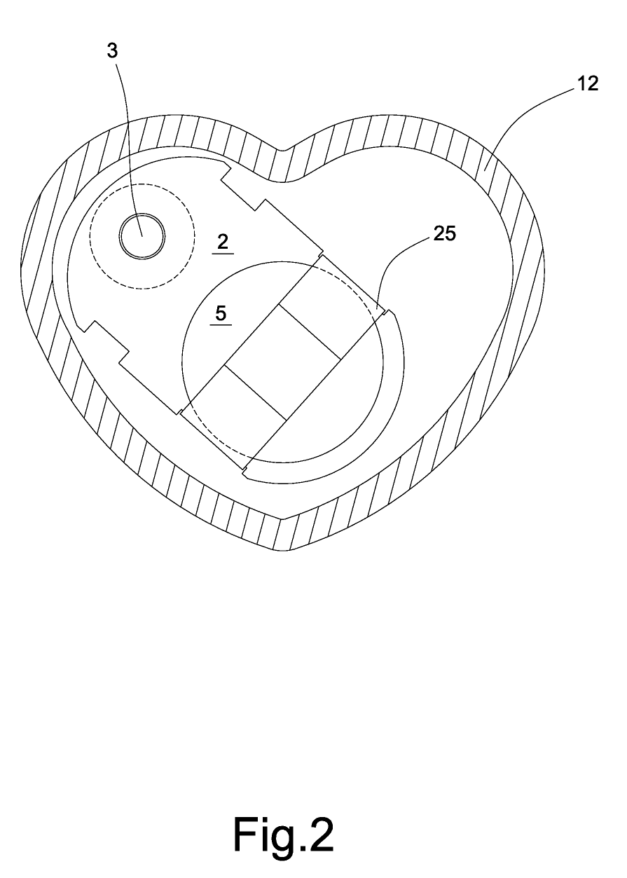

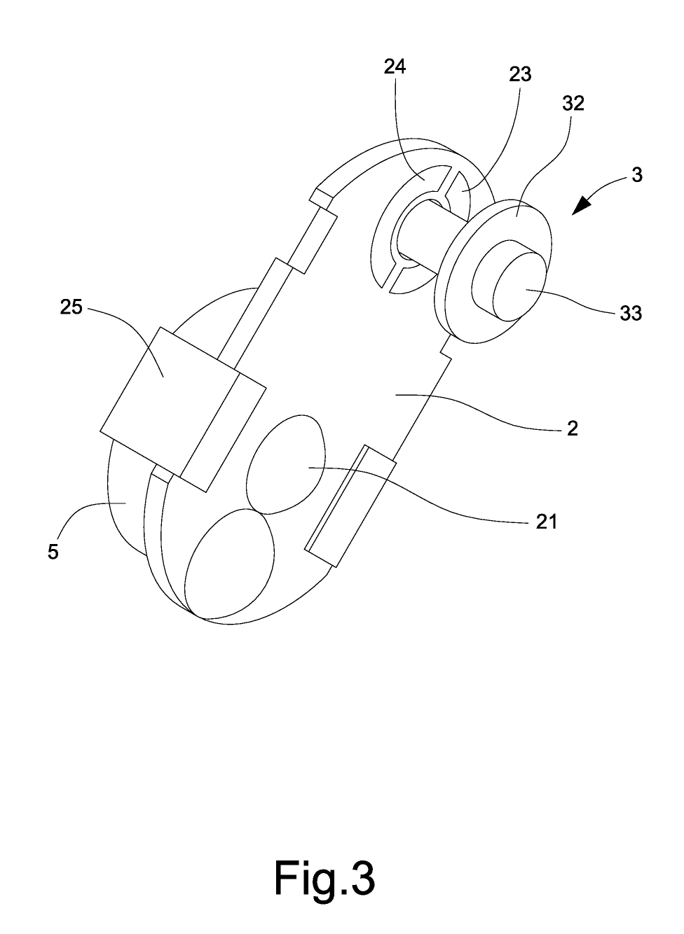

With reference to FIGS. 1 through 3, a triggering structure according to this invention may be embodied into a module unit 7, comprising a housing structured with a first shell 11 and a second shell 12, an inner circuit 2, a pillar 3, an elastic part 4, a light-emitting part 21, and a power supply unit 5.

The first shell 11 and the second shell 12 may be made into a structure in a random form. The first shell 11 is formed with a predetermined thru hole 111 and a further joint portion 112 that may be connected to a linking part 113; a predetermined positioning slot 121 is formed in the second shell 12.

The circuit body 2 is a circuit board comprising an electronic circuit and an IC, where a predetermined light-emitting part 21 is provided. A thru hole 22 is further provided, and two contact points 23 and 24 are formed around one side of the thru hole 22. The two contact points 23 and 24 disconnect from each other. In the embodiment, the two contact points 23 and 24 are in the form of a semi-circular arc, not remaining within the confines of what is required herein. In the circuit body 2, a retainer 25 is provided and combined with a power supply unit 5. The power supply unit 5 may be a battery.

The pillar 3 comprises an exposed end 31 where a predetermined round tablet 32 is provided, and the other end that serves as a positioning portion 33. The round tablet 32 is electrically conductive, or a conductive material may be provided on the round tablet 32.

The elastic part 4 is a spring.

With the members, one end of the plastic part 4 is arranged in positioning slot 121 and the other end is set around the positioning portion 33 of the pillar 3. The exposed end 31 of pillar 3 is made to pass in sequence through a thru hole 22 of the circuit body 2 and through a thru hole 111 of the first shell 11 and thus extends out of the thru hole 111. Then, the first shell 11 and the second shell 12 are combined, thereby a module unit 7 being formed.

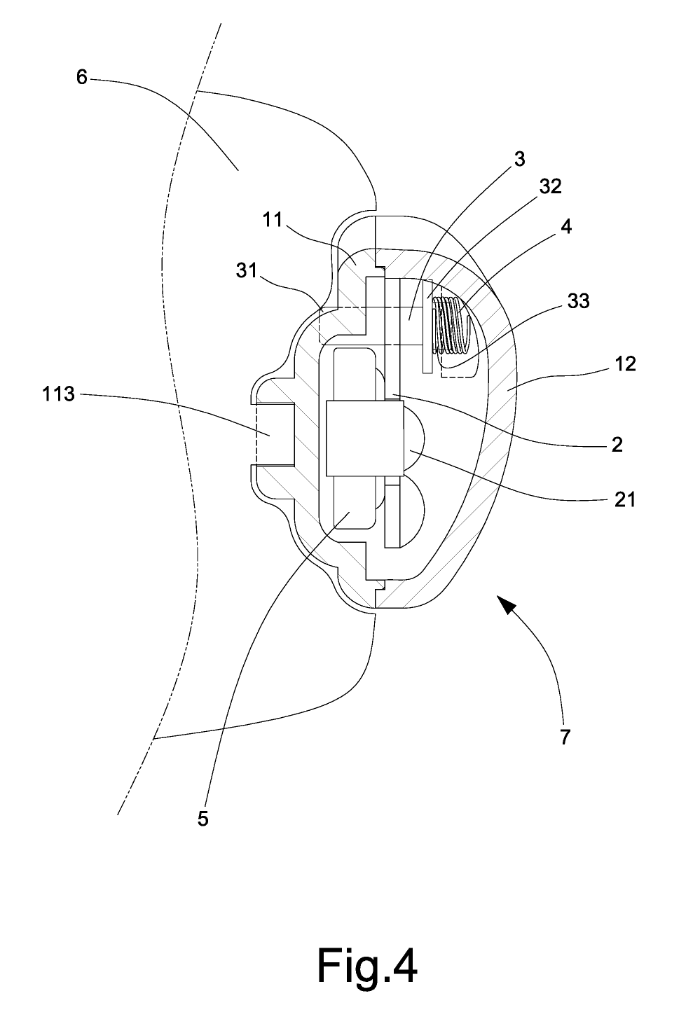

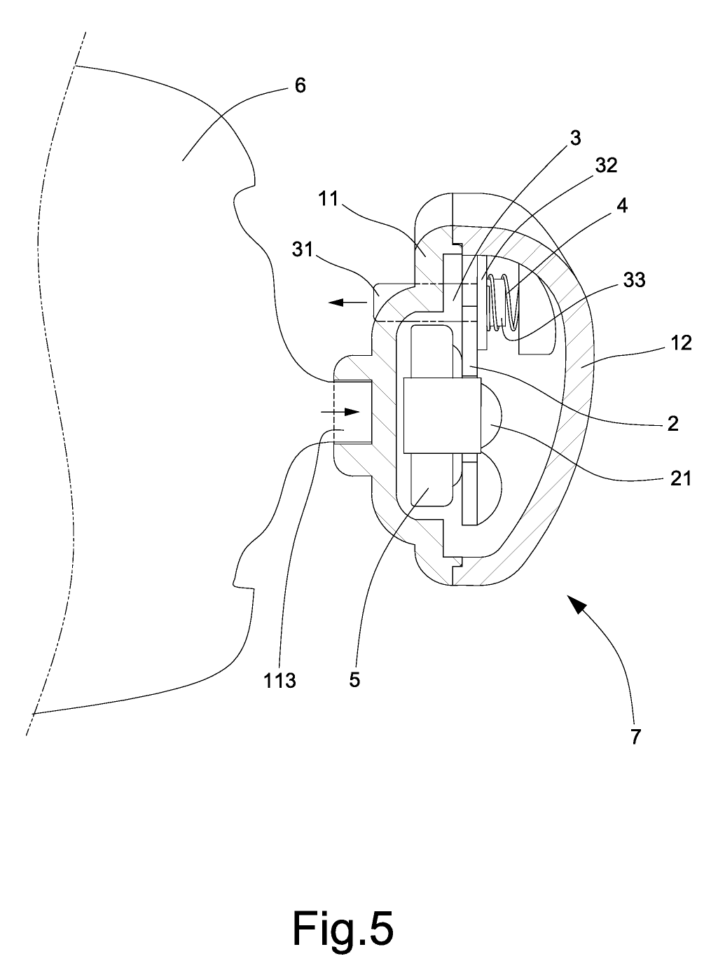

In this invention, the two contact points 23 and 24 are formed that disconnect from each other. When the exposed end 31 of the pillar 3 is inwards pushed with the external force, as shown in FIG. 4, the pillar 3 opposite to the first housing 11 contracts. Here, the round tablet 32 of the pillar 3 is kept separate from the circuit body 2 and thus the contact points 23 and 24 does not turn ON; in the design of circuit on the circuit body 2, the light-emitting part 21 may be made not to be bright. Contrarily, when the exposed end 31 of the pillar 3 is not pushed with the external force, as shown in FIG. 5, because the positioning portion 33 of the pillar 3 is driven by the elastic part 4, the pillar 3 opposite to the first shell 11 stretches out. Here, the round tablet 32 of the pillar 3 is kept close to the circuit body 2 and thus the contact points 23 and 24 turns ON; in the design of circuit on the circuit body 2, the light-emitting part 21 may be made to be bright.

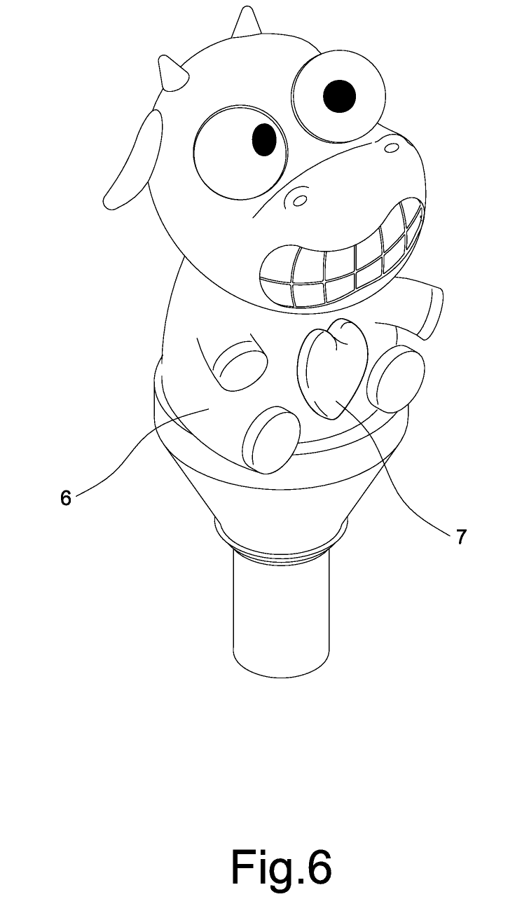

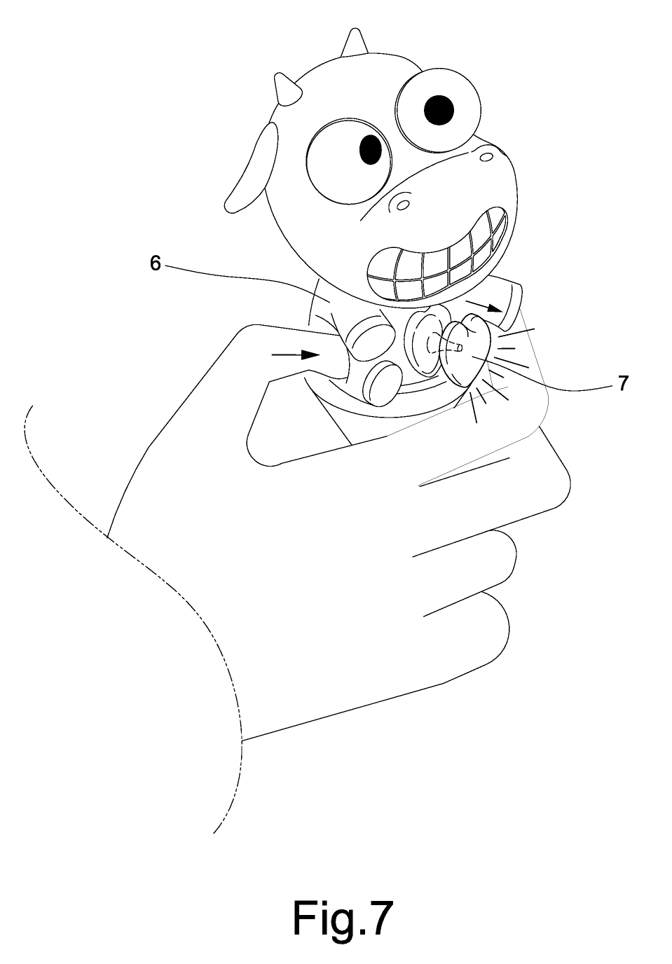

If the module unit 7 according to this invention is applied to a front side of an air-bag doll 6, as shown in FIGS. 4 and 6, when the air-bag doll 6 is not pressed, the module unit 7 is close to the air-bag doll 6, in the principle mentioned above, the light-emitting part 21 may be made not to be bright. However, when the air-bag doll 6 is squeezed, the module unit 7 shifts out of the air-bag doll 6, as in the principle explained above, the light-emitting part 21 may be made to be bright, as shown in FIGS. 5 and 7. It is apparent that the triggering structure according to this invention, when being applied, may specially serve as an automatic switch.

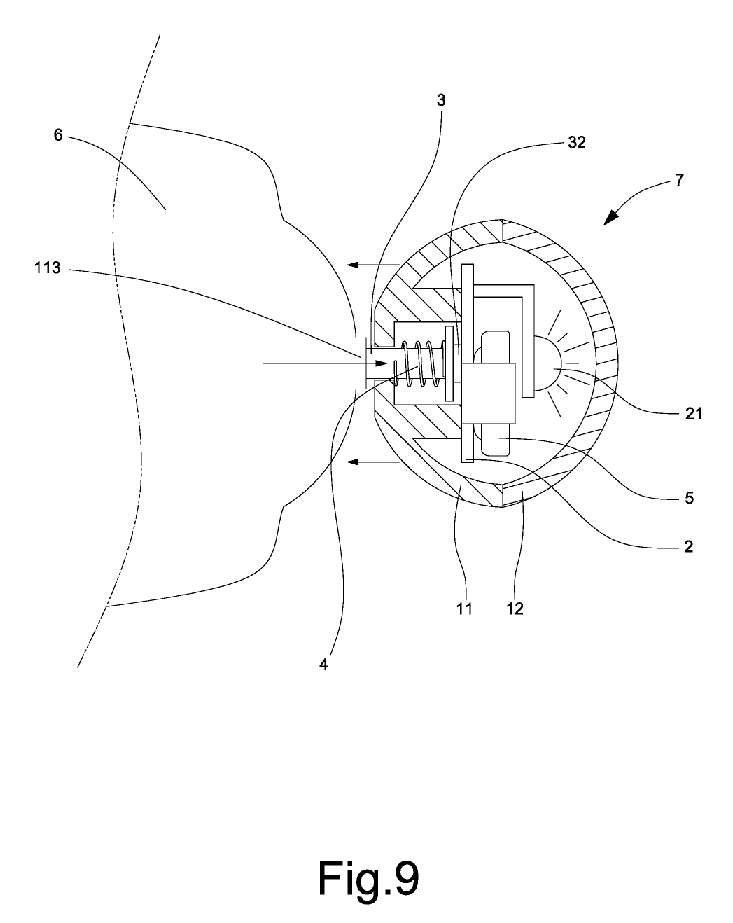

In this invention, the light-emitting part 21 may be changed into a sound-making part and also a sound-light part that is made up of the light-emitting part and the sound-making part. When the air-bag doll 6 is not squeezed, the pillar 3 is exposed and does not turn ON the two contact points (not shown); contrarily, as shown in FIG. 9, when the air-bag doll 6 is squeezed, the pillar 3 contracts and touches the circuit body 2, thereby the two contact points (not shown) being made to turn ON and light up.

To sum up, the triggering structure according to this invention, when being applied to the module unit and various products, is featured with automatic switching. This invention may be used in industries. This invention is indeed unprecedented and has not been published and not similar to any other product in the market. To sum up, this invention, an invented product hard to come by, available, novel, and progressive in the industry, completely meet the requirements of application for the patent, and hence we apply following the patent law; we earnestly request you to examine it for details and to approve the patent as soon as possible for protection of the inventor's rights and interests.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1 A triggering structure, comprising:
a housing, one side of which is formed with a predetermined thru hole;
a circuit body that is provided inside the housing and formed into a circuit board, comprising an electronic circuit and an IC, where two contact points are formed that disconnect from each other;
a power supply unit that may supply power to the circuit body;
a pillar that may partially stretch out of the thru hole of the housing and shift inwards or outwards to turn ON the two contact points that disconnect from each other on the circuit body; and
an elastic part set around the pillar;
with the members, the pillar shifting inwards or outwards when being pushed with an external force, and thus making the contact points disconnecting from each other turn ON or OFF.

2. The triggering structure according to claim 1, wherein the housing comprises a first shell and a second shell, a thru hole is formed on the first shell, a joint portion is further formed to connect to a linkage part, and a determined positioning slot is formed in the second shell.

3. The triggering structure according to claim 2, wherein one end of the elastic part is arranged in the positioning slot and the elastic part is a spring.

4. The triggering structure according to claim 1, wherein one or both of the light-emitting part and sound-making part are provided at a predetermined area of the circuit body.

5. The triggering structure according to claim 1, wherein a retainer is provided on the circuit body to connect to the power supply unit.

6. The triggering structure according to claim 1, wherein a thru hole is formed on the circuit body and each of the contact points disconnecting from each other is formed at the edge of thru hole.

7. The triggering structure according to claim 1, wherein the two contact points disconnecting from each other may be in the form of a semi-circular arc opposite to each other.

8. The triggering structure according to claim 1, wherein the pillar comprises an exposed end where a predetermined round tablet is provided, and the other end that serves as a positioning portion set around the elastic part.

9. The triggering structure according to claim 8, wherein the round tablet is electrically conductive or a conductive material may be provided on the round tablet.

10. The triggering structure according to claim 9, wherein a thru hole is formed on the circuit body, the contact points disconnecting from each other are formed near the thru hole on the circuit body, the exposed end of the pillar passes through the thru hole on the circuit body and that on the housing, and the round tablet of the pillar is opposite the two contact points disconnecting from each other.
